(19) United States
(12) Patent Application Publication
(10) Pub. No.: US 2013/0196610 A1
(43) Pub. Date: Aug. 1, 2013

(54) WIRELESS COMMUNICATION SYSTEM

(71) Applicants: DENSO CORPORATION, Kariya-city (JP); Nippon Soken, Inc., Nishio (JP)

(72) Inventors: Kenichiro Sanji, Okazaki-city (JP); Munenori Matsumoto, Kariya-city (JP); Takatoshi Sekizawa, Kariya-city (JP); Masahiro Sugiura, Takahama-city (JP); Nobuya Watabe, Nagoya-city (JP); Akira Takaoka, Okazaki-city (JP); Takashi Saitou, Okazaki-city (JP)

(73) Assignees: Nippon Soken, Inc., Nishio (JP); DENSO CORPORATION, Kariya-city (JP)

(21) Appl. No.: 13/753,020

(22) Filed: Jan. 29, 2013

(30) Foreign Application Priority Data
Jan. 30, 2012 (JP) 2012-016593
Jun. 6, 2012 (JP) 2012-129239

(51) Int. Cl. H04W 4/00

(52) U.S. Cl. CPC H04W 4/008
USPC 455/193.1

(57) ABSTRACT

A first communication apparatus and a second communication apparatus are capable of wireless communication with each other. The first communication apparatus has a normal operation mode and a tuning mode that differs from the normal operation mode and allows a variable matching portion to adjust a matching state. When the tuning mode is selected, the first transmission portion transmits an operation mode transition request signal to the second communication apparatus. A first reception portion receives a tuning reference signal transmitted from the second communication apparatus in response to the operation mode transition request signal. A reception signal intensity measurement portion measures a reception signal intensity of the received tuning reference signal. The variable matching portion adjusts a matching state based on the measured reception signal intensity of the tuning reference signal.

### CROSS REFERENCE TO RELATED APPLICATIONS

This application is based on Japanese Patent Applications No. 2012-16593 filed on Jan. 30, 2012, and No. 2012-129239 filed on Jun. 6, 2012, the disclosures of which are incorporated herein by reference.

### TECHNICAL FIELD

The present disclosure relates to a wireless communication system suitably used for a smart keyless entry system of a vehicle.

### BACKGROUND

Patent document 1 discusses the method and the apparatus to automatically tune a radio antenna of a radio receiver that receives information packets. For this purpose, a tuning element is connected to the antenna. While sweeping the antenna over the entire tuning area, the apparatus monitors the received signal strength indication (RSSI) or the electric field strength of a radio wave to detect a value of the tuning element that generates the maximum RSSI signal. After the sweep is complete, the apparatus sets the tuning element to a value that allows the antenna to generate the maximum RSSI signal.

According to patent document 1, the antenna receives a radio wave for radio broadcasting. The received power (hereinafter also referred to as “antenna received power”) is used to successively vary the matching state of an antenna tuning circuit under control of an antenna tuning control circuit. The variation is measured as the received signal strength indication (RSSI) to detect the maximum matching state based on the RSSI. An optimal antenna matching state (i.e., reception state) is thereby generated.

The antenna matching according to the configuration described in patent document 1 requires the antenna received power being stable. The reason is as follows. Suppose a case of controlling to sweep the antenna tuning circuit if the antenna received power is unstable. In such a case, it is difficult to determine whether the received signal strength indication varies with a change in the antenna matching state or a change in the antenna received power. The radio broadcast uses amplitude modulation (AM) or frequency modulation (FM). Neither modulation system ensures the stable received power.

The AM system varies the amplitude and therefore the received power also varies. In the FM system, a filter used for the demodulator indicates frequency characteristics. The FM system varies the amplitude of a modulation wave and therefore the received power also varies. In phase modulation (PM), the transmission system includes a filter that removes “side lobe” as a slight electromagnetic wave radiated in a direction different from the targeted direction. After passing through the filter, the voltage waveform blunts at a point where the output voltage varies. The modulation wave partially contains unstable amplitude.

As a rapidly spreading technology, the smart keyless entry system is capable of controlling the door lock or unlock and the engine start without using a mechanical key if the wireless authentication is established between an onboard unit mounted on a vehicle and a portable unit carried by a user on the vehicle. In the smart keyless entry system, however, the frequency of a radio wave from the portable unit may differ from the resonant frequency of a reception portion in the onboard unit to cause a mismatch between the reception portion and the antenna depending on positional relationship between the onboard unit and the portable unit or depending on a state in which the user holds the portable unit.

The wireless communication for the smart keyless entry system uses amplitude-shift keying (ASK), frequency shift keying (FSK), or phase shift keying (PSK). None of these systems ensures the stable received power, making it difficult to provide the antenna matching according to the configuration described in patent document 1.
Patent Document 1: Japanese Patent No. 3127229 (=U.S. Pat. No. 5,136,719)

### SUMMARY

It is an object of the present disclosure to provide a wireless communication system capable of more accurate antenna matching even in wireless communication using a communication system that does not ensure stable antenna received power.

According to an example aspect of the present disclosure, a wireless communication system includes: a first communication apparatus; and a second communication apparatus for wirelessly communicating with the first communication apparatus. The first communication apparatus includes: a first transmission portion that transmits a wireless signal to the second communication apparatus using a radio wave in a first frequency band; a first reception portion that receives a wireless signal from the second communication apparatus; a reception antenna connected to the first reception portion; a variable matching portion that variably adjusts a matching state between the first reception portion and the reception antenna within a predetermined matching range; a reception signal intensity measurement portion that measures a reception signal intensity of a wireless signal that is received by the first reception portion and is transmitted from the second communication apparatus; and an operation mode changeover control portion that switches an operation mode of the first communication apparatus between a normal mode and a tuning mode. The tuning mode is different from the normal mode, in which the first communication apparatus normally functions. The variable matching portion adjusts the matching state in the tuning mode. The first transmission portion transmits an operation mode transition request signal to the second communication apparatus when the operation mode changeover control portion changes the operation mode to the tuning mode. The first reception portion receives a tuning reference signal transmitted from the second communication apparatus in response to the operation mode transition request signal. The reception signal intensity measurement portion measures the reception signal intensity of the tuning reference signal received by the first reception portion. The variable matching portion adjusts the matching state based on the reception signal intensity of the tuning reference signal measured by the reception signal intensity measurement portion. The second communication apparatus includes: a second reception portion that receives a wireless signal from the first communication apparatus; a second transmission portion that transmits a wireless signal to the first communication apparatus; and a signal determination portion that determines whether a wireless signal received by the second reception portion and transmitted from the first communication apparatus is equivalent to the operation mode transition request signal. The second transmission portion transmits the tuning reference signal using a radio wave in a second frequency band when the wireless signal received from the first communication apparatus is equivalent to the operation mode transition request signal.

The above-mentioned configuration can accurately adjust the matching state using the tuning reference signal different from wireless signals normally received for broadcasting or data communication. Since the matching state is adjusted in a state different from the normal operation mode, the normal wireless communication is not affected. The matching state can be adjusted according to a simpler configuration. In this case, a normal communication system can more accurately adjust the matching state.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a system configuration of a wireless communication system according to an example embodiment;

FIG. 2 is a diagram showing a variable matching circuit and an RF reception circuit;

FIG. 3 is a diagram showing another example of the variable matching circuit;

FIG. 4 is a flowchart illustrating a process on the onboard unit;

FIG. 5 is a flowchart illustrating a process on the portable unit;

FIG. 6 is a diagram showing an overview of antenna matching;

FIG. 7 is a flowchart illustrating another example of the process on the onboard unit;

FIG. 8 is a diagram showing a method of determining whether a radio wave is stably received;

FIG. 9 is a diagram showing the method of determining whether a radio wave is stably received;

FIG. 10 is a diagram showing a method of determining whether a radio wave is stably received;

FIG. 11 is a diagram showing the method of determining whether a radio wave is stably received;

FIG. 12 is a flowchart illustrating another example of the process on the onboard unit;

FIG. 13 is a diagram showing a method of determining the tuning reliability;

FIG. 14 is a diagram showing a method of determining the tuning reliability;

FIG. 15 is a flowchart illustrating another example of the process on the onboard unit;

FIG. 16 is a diagram showing relationship among the RSSI, the demodulated signal, and the trigger in FIG. 15;

FIG. 17 is a diagram showing relationship between the variable capacitance value and the RSSI;

FIG. 18 is a flowchart illustrating another example of the process on the onboard unit in FIG. 15;

FIGS. 19A and 19B are diagrams showing a variation in variable capacitance voltage and resonant frequency of a comparison; and

FIGS. 20A and 20b are diagrams showing a variation in variable capacitance voltage and resonant frequency according to the present embodiment.

### DETAILED DESCRIPTION

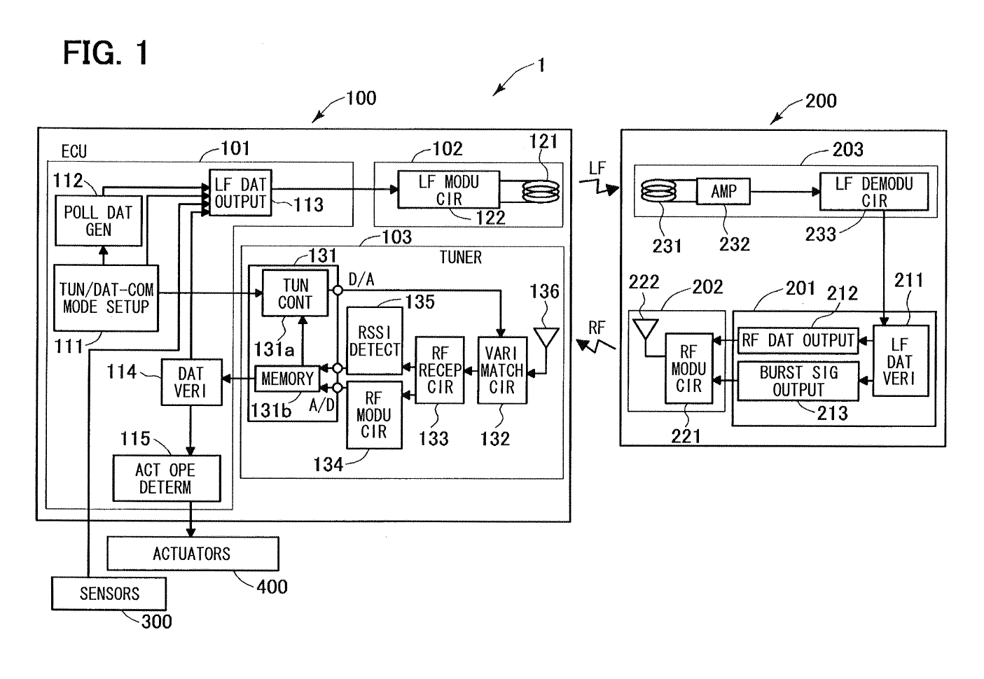

With reference to the accompanying drawings, the following describes examples of applying the wireless communication system according to the present disclosure to a smart keyless entry system. FIG. 1 illustrates a system configuration of a smart keyless entry system 1. The system includes an onboard unit 100 mounted on a vehicle and a portable unit 200 carried by a user. The onboard unit 100 is equivalent to a first communication apparatus according to the present disclosure. The portable unit 200 is equivalent to a second communication apparatus according to the present disclosure.

The onboard unit 100 includes an ECU (electronic control unit) 101, an LF transmission portion 102, and a tuner 103. The LF transmission portion 102 and the tuner 103 are connected to the ECU 101. The ECU 101 may include the tuner 103 (or only a control circuit 131).

The ECU 101 is provided with a control circuit including a known microcomputer, memory to store a control program, and a signal input/output circuit communicating with an external circuit.

The ECU 101 includes a tuning mode or data communication mode setup portion (also referred to as an operation mode setup portion) 111, a polling data generation portion 112, and an LF data output portion 113. The tuning mode or data communication mode setup portion 111 selects and sets an operation mode. The polling data generation portion 112 generates polling data or LF data as transmission data to the portable unit 200. The LF data output portion 113 outputs polling data or LF data based on states of the portions in the ECU 101 and a sensor group 300 such as states of a door lock, an engine, or a battery. The tuning mode or data communication mode setup portion 111 is equivalent to an operation mode changeover control portion according to the present disclosure.

The ECU 101 also includes a data verification portion 114 and an actuator operation determination portion 115. The data verification portion 114 verifies data (e.g., ID code of the portable unit) transmitted from the portable unit 200 and a master code stored in memory 131b or memory included in the data verification portion 114. Based on a verification result from the data verification portion 114, the actuator operation determination portion 115 determines whether an actuator group 400 for the door lock apparatus or the engine is operable. The actuator operation determination portion 115 is equivalent to an operation permission portion according to the present disclosure.

The above-mentioned portions represent the inside of the ECU 101 according to the functions. Actually, the microcomputer performs a control program stored in the memory to implement these functions.

The LF transmission portion 102 includes an LF modulation circuit 122 and an LF transmission antenna 121. The LF modulation circuit 122 modulates an output signal from the LF data output portion 113 according to a specified modulation system such as FSK or ASK described above, for example. The LF transmission portion 102 uses a transmission frequency band such as an LF band or a VLF band (low-frequency band or extra-low-frequency band equivalent to a first frequency band according to the present disclosure). The LF transmission portion 102 is equivalent to a first transmission portion or a polling signal transmission portion according to the present disclosure.

The tuner 103 includes a control circuit 131, a variable matching circuit 132 (to be described), an RF reception circuit 133 (to be described), an RF modulation circuit 134, an RSSI detection circuit 135, and an RF reception antenna 136. The RSSI detection circuit 135 detects the RSSI as a voltage value. The variable matching circuit 132, the RF reception circuit 133, the RF modulation circuit 134, the RSSI detection circuit 135, and the RF reception antenna 136 are connected to the control circuit 131. The tuner 103 is equivalent to a first reception portion or an ID code reception portion according to the present disclosure. The RF modulation circuit 134 is equivalent to a demodulation portion according to the present disclosure. The RSSI detection circuit 135 is equivalent to a reception signal intensity measurement portion according to the present disclosure. The RF reception antenna 136 is equivalent to a reception antenna according to the present disclosure.

The control circuit 131 includes a tuning control portion 131a, memory 131b, and a signal input/output circuit (not shown). The tuning control portion 131a includes a microcomputer and a peripheral circuit according to a known technology. The memory 131b uses a nonvolatile storage. The control circuit 131 includes an A/D converter and a D/A converter (neither shown) according to a known technology. The tuning control portion 131a is equivalent to a continued adjustment determination portion or a matching result determination portion according to the present disclosure. The memory 131b is equivalent to a storage portion according to the present disclosure.

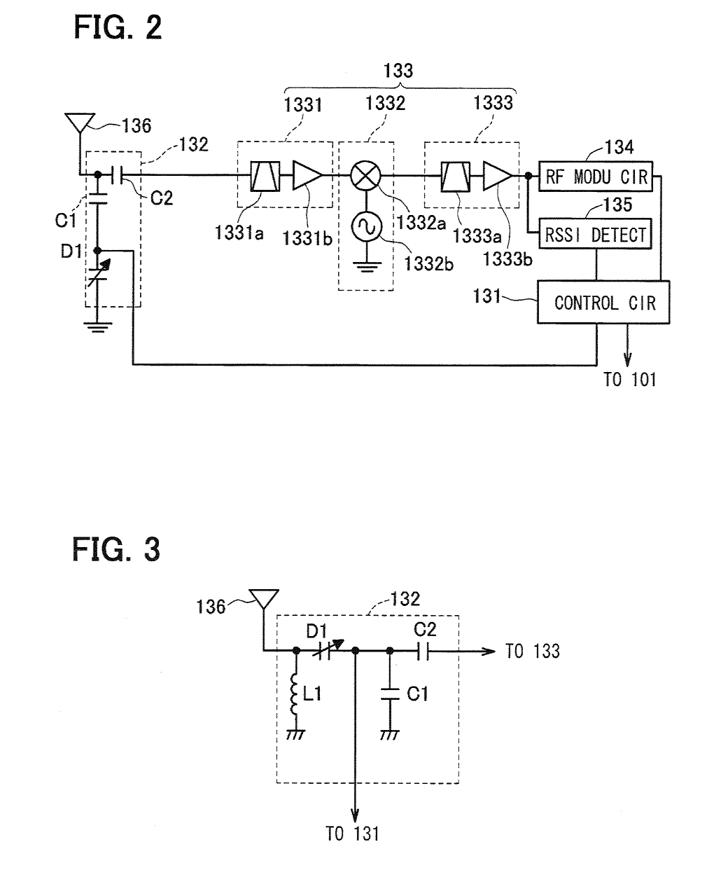

FIG. 2 illustrates the variable matching circuit 132 and the RF reception circuit 133 in detail. The variable matching circuit 132 includes capacitors C1 and C2, and a variable matching element D1. The capacitor C1 is connected in series between an output terminal of the RF reception antenna 136 and the ground. The variable matching element D1 is provided as a known variable capacitance diode (or varactor diode), for example, and varies the electrostatic capacitance according to an applied voltage. The capacitor C2 is connected between the output terminal of the RF reception antenna 136 and the RF reception circuit 133 and removes direct current components from an antenna current. The capacitor C2 also functions as a matching element for antenna impedance. The variable matching circuit 132 is equivalent to a variable matching portion according to the present disclosure.

The variable matching circuit 132 configures a bandpass filter and passes a targeted frequency. The bandpass filter uses a resonant frequency as the center frequency. The resonant frequency depends on an inductance for the RF reception antenna 136 and a combined capacitance of the variable matching element D1 and the capacitors C1 and C2. The control circuit controls the capacitance of the variable matching element D1 by varying a voltage applied to the variable matching element D1. The variable matching element D1 may be provided as a variable capacitance capacitor.

The RF reception circuit 133 includes a high-frequency amplifier circuit 1331, a frequency converter circuit 1332, and an intermediate frequency amplifier circuit 1333. The high-frequency amplifier circuit 1331 includes a bandpass filter 1331a and an amplifier 1331b and selects and amplifies an input signal. The frequency converter circuit 1332 includes a mixer 1332a and a local oscillator 1332b. The intermediate frequency amplifier circuit 1333 includes a bandpass filter 1333a and an amplifier 1333b. The circuit configurations and operations are already known as the superheterodyne system, for example, and a detailed description is omitted for simplicity.

FIG. 3 illustrates another example of the variable matching circuit. The variable matching circuit 132 includes a coil L1, capacitors C1 and C2, and a variable matching element D1. The coil L1 is connected between the output terminal of the RF reception antenna 136 and the ground. The variable matching element D1 and the capacitor C2 are connected between the output terminal of the RF reception antenna 136 and the RF reception circuit 133. The capacitor C1 is connected between the variable matching element D1 and the capacitor C2 and is also connected to the ground.

The variable matching circuit 132 configures a bandpass filter and passes a targeted frequency. The bandpass filter uses a resonant frequency as the center frequency. The resonant frequency depends on inductances for the RF reception antenna 136 and the coil L1 and a combined capacitance of the variable matching element D1 and the capacitors C1 and C2.

Now returning back to FIG. 1, the portable unit 200 will be described in detail. The portable unit 200 includes a portable unit control portion 201, an RF transmission portion 202 connected to the portable unit control portion 201, and an LF reception portion 203.

The portable unit control portion 201 is provided with a control circuit including a known microcomputer, memory to store a control program, and a signal input/output circuit communicating with an external circuit. The portable unit control portion 201 includes an LF data verification portion 211, an RF data output portion 212, and a burst signal output portion 213 as functions. The LF data verification portion 211 verifies LF data as transmission data from the onboard unit with reference to previously stored verification data. The RF data output portion 212 generates and outputs RF data based on a verification result from the LF data verification portion 211. The burst signal output portion 213 generates and outputs a burst signal (e.g., an RF-band continuous wave with output time of 10 msec) based on a verification result from the LF data verification portion 211. The LF data verification portion 211 is equivalent to a signal determination portion according to the present disclosure. The burst signal is equivalent to a tuning reference signal according to the present disclosure.

The RF transmission portion 202 outputs RF data or a burst signal. For example, the RF transmission portion 202 includes an RF modulation circuit 221 and an RF transmission antenna 222. The RF modulation circuit 221 modulates RF data using a specified modulation system such as FSK or ASK. The RF transmission portion 202 uses a transmission frequency band such as an RF band (a high-frequency band equivalent to a second frequency band according to the present disclosure). The RF transmission portion 202 is equivalent to a second transmission portion or an ID code transmission portion according to the present disclosure.

The LF reception portion 203 receives LF data as transmission data from the onboard unit. The LF reception portion 203 includes an LF reception antenna 231, an amplifier 232, and an LF demodulation circuit 233. The amplifier 232 amplifies a received signal to a specified level. The LF demodulation circuit 233 demodulates a received signal. The LF reception portion 203 is equivalent to a second reception portion or a polling signal reception portion according to the present disclosure.

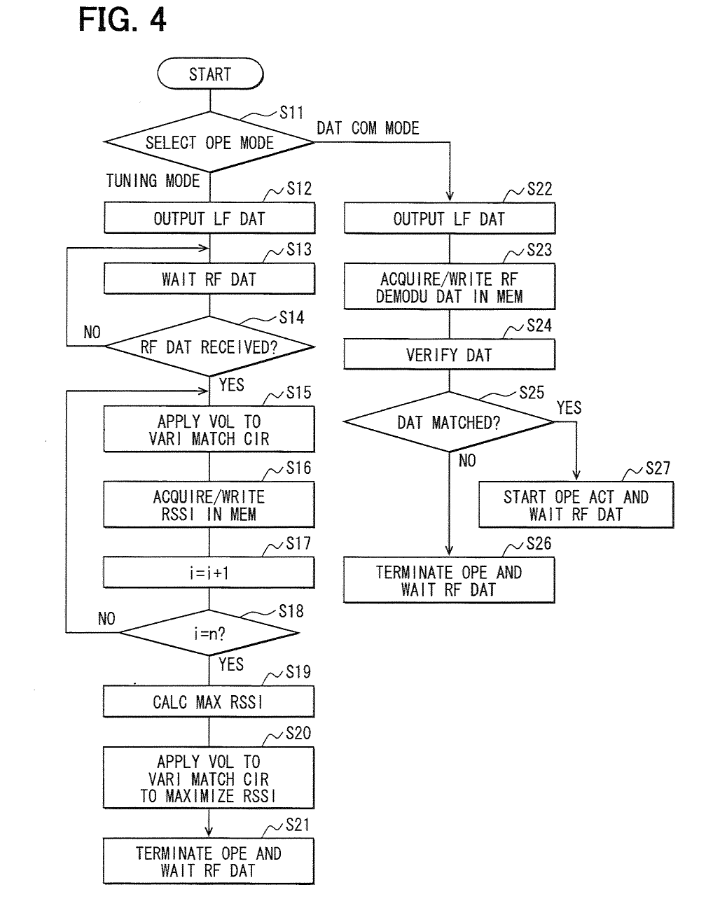

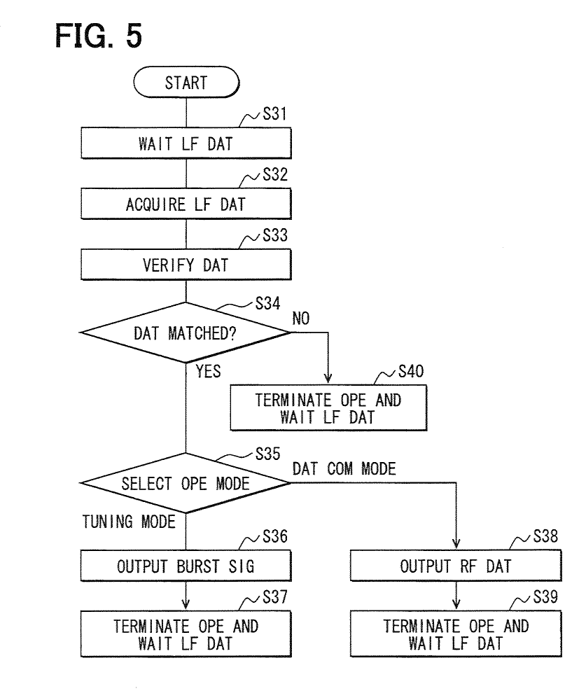

With reference to FIGS. 4 and 5, the following describes an onboard unit process and a portable unit process for antenna matching according to the present disclosure. The onboard unit process in FIG. 4 is performed on the ECU 101 (alternatively on the control circuit 131 of the tuner 103). The ECU 101 first allows the operation mode setup portion 111 to select one of the following operation modes.
Data communication mode: Normal operation mode (normal operation mode according to the present disclosure) of the smart keyless entry system 1.
Tuning mode: Operation mode to adjust a matching state of the variable matching circuit 132.

The ECU 101 may select the tuning mode as the operation mode if one of the following conditions is satisfied during operation in the data communication mode (S11).
Arrival of a predetermined mode transition timing such as a cycle of 100 msec, for example.
Unsuccessful reception of a radio wave (RF data) from the portable unit 200 over a predetermined time.

If the tuning mode is selected as the operation mode, the polling data generation portion 112 generates LF data (i.e., operation mode transition request signal) indicating that the tuning mode is selected as the operation mode. The LF transmission portion 102 transmits the LF data output from the LF data output portion 113 (S12). The onboard unit 100 awaits RF data (i.e., tuning reference signal or burst signal) from the portable unit 200 (S13).

The RF modulation circuit 134 or the RSSI detection circuit 135 detects a radio wave from the portable unit 200 via the RF reception antenna 136, the variable matching circuit 132, and the RF reception circuit 133. The control circuit 131 of the tuner 103 allows the tuning control portion 131a to set i=1 if the RF reception circuit 133 receives the RF data, i.e., the tuning reference signal (Yes at S14). The control circuit 131 sets a voltage (Vi or V1) to be applied to the variable matching circuit 132 (i.e., variable matching element D1). The control circuit 131 converts the digital value into an analog voltage and applies it to the variable matching circuit 132 (S15). The RSSI detection circuit 135 detects the RSSI (equivalent to the voltage value). The control circuit 131 stores the RSSI in association with the applied voltage Vi in the memory 131b (S16).

The control circuit 131 then increments i by 1 to vary the applied voltage Vi (S17). The control circuit 131 applies the voltage to the variable matching circuit 132 and stores the corresponding RSSI in association with the applied voltage Vi in the memory 131b. The control circuit 131 finds the maximum RSSI value stored in the memory 131b (S19) when value i reaches n, where n is a positive number greater than 1 and is settled in accordance with the applied voltage Vi or a range of variations in the resonant frequency of the RF antenna 136.

The control circuit 131 applies the applied voltage Vi associated with the maximum RSSI to the variable matching circuit 132 (S20). The control circuit 131 stores the Vi value as an optimum matching voltage in the memory 131b. Finally, the ECU 101 terminates the operation in the tuning mode, transitions to the data communication mode, and awaits RF data from the portable unit 200 (S21).

If the data communication mode is selected as the operation mode at S11, the operation is similar to that of the smart keyless entry system 1 of the related art. The data communication mode is simply outlined below.

At a predetermined polling timing, the polling data generation portion 112 of the ECU 101 generates LF data (polling data in this case) indicating that the data communication mode is enabled. The LF transmission portion 102 transmits the LF data output from the LF data output portion 113 (S22). The ECU 101 awaits RF data (ID code in this case) from the portable unit 200.

When the RF reception circuit 133 of the tuner 103 receives RF data, the RF modulation circuit 134 demodulates the RF data. The tuning control portion 131 acquires the RF demodulation data and transmits it to the ECU 101. The ECU 101 acquires the RF demodulation data (i.e., ID code) and stores it in the memory 131b (S23).

The ECU 101 allows the data verification portion 114 to verify the ID code acquired from the portable unit 200 with reference to the master data previously stored in the memory 131b (S24), for example. If the verification result indicates a match between them (Yes at S25), the actuator operation determination portion 115 determines whether to enable an actuator operation. The actuator operation determination portion 115 outputs a control instruction to the actuator group 400 according to a user operation or the state of the sensor group 300. The ECU 101 then awaits RF data from the portable unit 200 (S27).

If the verification result indicates a mismatch between them (No at S25), the ECU 101 then awaits RF data from the portable unit 200 (S26).

FIG. 5 illustrates a portable unit process performed on the portable unit control portion 201 of the portable unit 200. The portable unit 200 first awaits LF data from the onboard unit 100 (S31). The LF reception portion 203 acquires LF data (S32). The LF data verification portion 211 then verifies the acquired LF data (S33). For example, the LF data verification portion 211 checks if the acquired LF data matches data contained in a data table stored in the LF data verification portion 211.

The portable unit 200 awaits LF data from the onboard unit 100 (S40) if the verification result indicates a mismatch between the acquired LF data and data in the data table (No at S34).

The portable unit control portion 201 determines the operation mode of the onboard unit 100 based on the LF data if the verification result indicates a match between the acquired LF data and data in the data table (Yes at S34). The RF data output portion 212 generates and outputs RF data containing an ID code specific to the portable unit 200 if the data communication mode is selected as the operation mode of the onboard unit 100. The RF modulation circuit 221 of the RF transmission portion 202 modulates the RF data according to a specified modulation system. The RF data is output via the RF transmission antenna 222 (S38). The portable unit 200 awaits LF data from the onboard unit 100 (S39).

The burst signal output portion 213 generates and outputs a burst signal if the tuning mode is selected as the operation mode of the onboard unit 100. The RF modulation circuit 221 performs no modulation if the burst signal is output as a continuous wave. The RF modulation circuit 221 performs modulation if the burst signal is output as a modulation wave. The burst signal is then output via the RF transmission antenna 222 (S36). The portable unit 200 awaits LF data from the onboard unit 100 (S37).

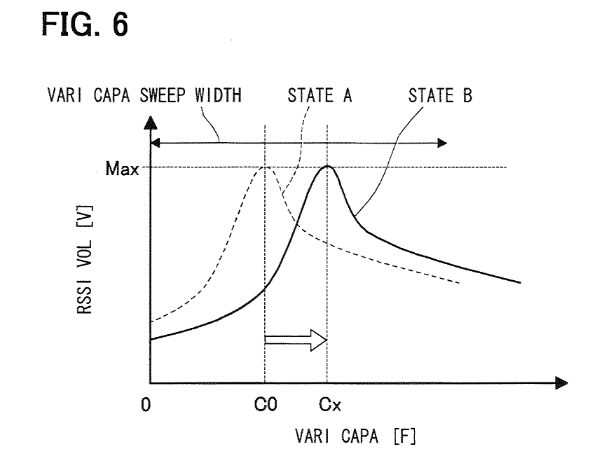

The following outlines the antenna matching according to the present disclosure with reference to FIG. 6. Suppose the onboard unit 100 receives a burst signal from the portable unit 200 as described above. The onboard unit 100 then varies the voltage (Vi) applied to the variable matching element D1 between 0 and 1 V or between 0 and 2 V (i.e., variable capacitance value sweep width), for example. The onboard unit 100 varies the capacitance of the variable matching element D1 and measures the RSSI (converted into a voltage value). The onboard unit 100 finds the capacitance of the variable matching element D1 to cause a maximum RSSI value (Max). The voltage (Vi) to generate the capacitance is assumed to be the final applied voltage. The corresponding frequency is assumed to be the resonant frequency for the RF reception antenna 136.

Suppose a case where the RSSI measurement result changes from state A to state B to change the resonant frequency. In such a case, the onboard unit 100 is highly unlikely to receive a radio wave from the portable unit 200 if the variable matching element D1 is set to capacitance C0 according to a related art. According to the configuration of the present disclosure, however, correct tuning is available even if the RSSI measurement result changes to state B because the capacitance of the variable matching element D1 can be estimated as Cx to cause the maximum RSSI value at the next tuning timing.

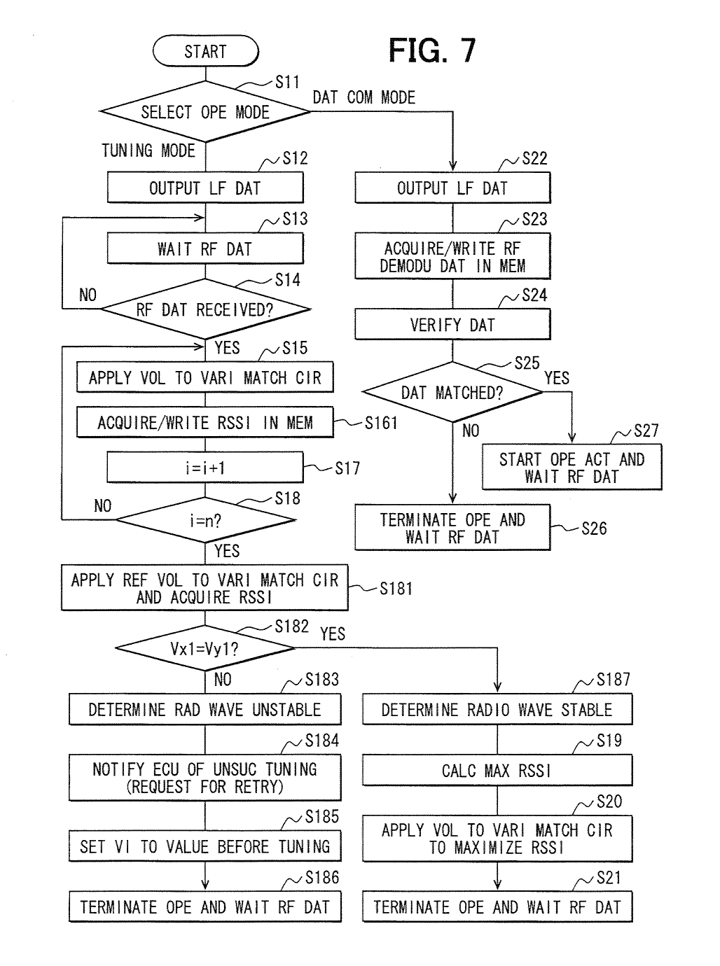

With reference to FIG. 7, the following describes another example of the onboard unit process and the portable unit process for the antenna matching according to the present disclosure. The onboard unit process is a modification of FIG. 4. The mutually corresponding parts in FIGS. 7 and 4 are designated by the same reference numerals and a detailed description is omitted for simplicity. The portable unit process is similar to that illustrated in FIG. 5.

If the data communication mode is selected as the operation mode at S11, the onboard unit 100 performs the same process (S22 through S27) in FIG. 4 and a description is omitted.

If the tuning mode is selected as the operation mode at S11, the onboard unit 100 transmits LF data (S12) and awaits RF data from the portable unit 200 (S13). If RF data is received (Yes at S14), the control circuit 131 of the tuner 103 allows the tuning control portion 131a to set i=1. The control circuit 131 sets a voltage (Vi or V1) to be applied to the variable matching circuit 132 (i.e., variable matching element D1). The control circuit 131 converts the digital value into an analog voltage and applies it to the variable matching circuit 132 (S15). The RSSI detection circuit 135 detects the RSSI (i.e., Vx1). The control circuit 131 stores the RSSI in association with the applied voltage V1 in the memory 131b (S161).

The control circuit 131 then increments i by 1 to vary the applied voltage V1 (S17). The control circuit 131 applies the voltage to the variable matching circuit 132 and stores the corresponding RSSI (Vxi) in association with the applied voltage Vi in the memory 131b. If i=n is satisfied (Yes at S18), the control circuit 131 assumes Vi for i=1 to be reference voltage V1, for example, and again applies the voltage to the variable matching circuit 132. The control circuit 131 assumes the detected RSSI to be Vy1 (S181).

The reference voltage does not need to equal the voltage V1 at the beginning of the tuning. The reference voltage may be equivalent to a voltage corresponding to the largest RSSI value or a voltage expected to allow the RSSI value to exceed a predetermined value. This decreases a circuit noise effect and increases the RSSI value. An accurate value is available, increasing the accuracy in determining the reception state of a radio wave. The reason is as follows. The voltage for RSSI causes the noise voltage to vary with a ratio between the RF signal intensity and the circuit noise. The circuit noise effect needs to be avoided to maintain the RF signal intensity as high as possible.

The control circuit 131 compares Vx1 with Vy1 that are acquired as described above. Suppose a case where Vx1 differs from Vy1 or a difference between Vx1 and Vy1 exceeds a predetermined range (No at S182). In such a case, the control circuit 131 assumes the radio wave reception state to be unstable (S183). The tuner 103 outputs a signal to the ECU 101 to indicate that the tuning fails (S184). At this time, the tuner 103 may output a request to retry the tuning.

The control circuit 131 sets voltage Vi to be applied to the variable matching circuit 132 to the value that is stored in the memory 131b and takes effect before the tuning, namely, the optimum matching voltage for the previous tuning (S185). The onboard unit 100 terminates the operation in the tuning mode and awaits RF data from the portable unit 200 (S186). The onboard unit 100 may transition to the data communication mode.

Suppose a case where Vx1 equals Vy1 or a difference between Vx1 and Vy1 is contained in a predetermined range (Yes at S182). In such a case, the control circuit 131 assumes the radio wave reception state to be stable (S187). The control circuit 131 calculates a maximum value from the RSSI or Vxi (i=1 through n) stored in the memory 131b (S19). The control circuit 131 applies Vi associated with Vxi to the variable matching circuit 132 (S20). The control circuit 131 stores the Vi value as an optimum matching voltage in the memory 131b. The onboard unit 100 terminates the operation in the tuning mode, transitions to the data communication mode, and awaits RF data from the portable unit 200 (S21).

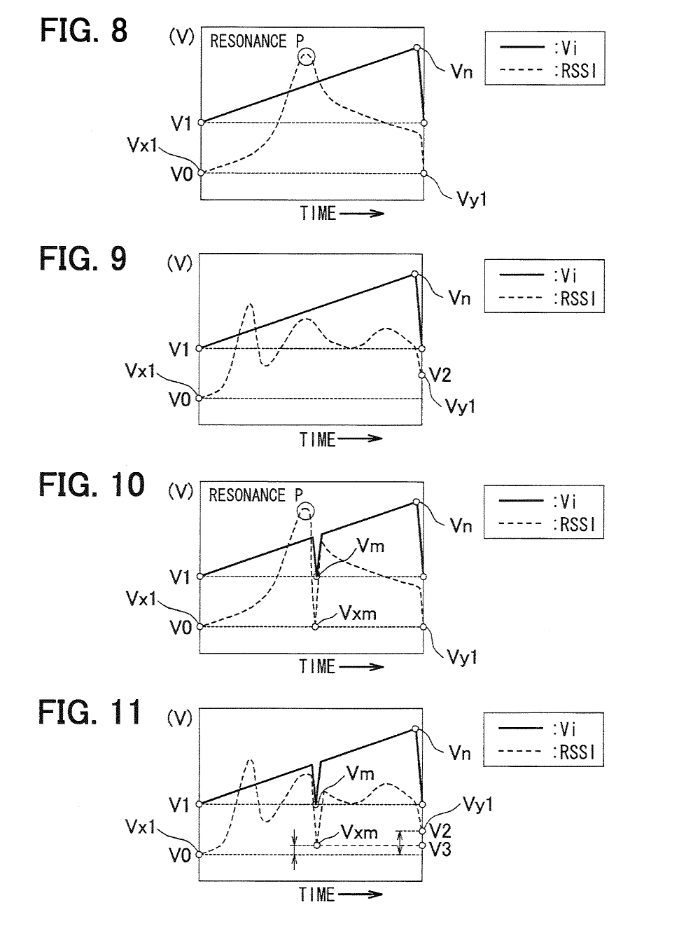

With reference to FIGS. 8 through 11, the following describes the method in FIG. 7 of determining whether the radio wave reception state is stable. These drawings illustrate changes in the RSSI (i.e., Vxi) in relation to the time when voltage Vi applied to the variable matching circuit 132 is changed from i=1 to n in succession.

In FIGS. 8 and 9, the onboard unit 100 applies the reference voltage V1 to the variable matching circuit when the tuning starts and after it terminates. The onboard unit 100 measures the corresponding RSSI. Based on two RSSI values, the onboard unit 100 determines whether the radio wave reception state is stable.

As illustrated in FIG. 8, for example, one RSSI peak (resonance point) is available if the radio wave reception state is stable. In this case, RSSI values Vx1 and Vy1 equal value V0 or a difference between them belongs to a predetermined range. Value Vx1 is found when V1 is applied to the variable matching circuit 132 at the beginning of the tuning. Value Vy1 is found when V1 is re-applied to the variable matching circuit 132 after the end of the tuning (i.e., after Vn is applied). Therefore, the matching state is adjustable.

As illustrated in FIG. 9, however, two or more RSSI peaks occur if the radio wave reception state is unstable. In this case, RSSI value Vy1 equals V2 and differs from RSSI value Vx1 that equals V0. Value Vy1 is found when V1 is re-applied to the variable matching circuit 132 after the end of the tuning Value Vx1 is found when V1 is applied to the variable matching circuit 132 at the beginning of the tuning. Therefore, no matching state is adjustable.

According to the configurations in FIGS. 8 and 9, the variable matching portion adjusts a matching state by assuming the matching state to be the reference state when the adjustment starts and after it terminates. The variable matching portion accordingly determines whether to continue adjusting the matching state of the variable matching portion based on the reception signal intensity of the tuning reference signal measured by the reception signal intensity measurement portion.

As illustrated in FIGS. 10 and 11, the timing to apply the reference voltage V1 is also provided for Vm (1<m<n) in the process of varying the applied voltage Vi. Increasing the number of timings to apply the reference voltage V1 improves the accuracy in determining the radio wave reception state.

As illustrated in FIG. 10, Vx1, Vxm, and Vy1 all equal value V0 if the radio wave reception state is stable. Therefore, the matching state is adjustable.

As illustrated in FIG. 11, however, Vx1, Vxm, and Vy1 correspond to V0, V3, and V2, respectively, or a difference among them exceeds a predetermined range. Therefore, no matching state is adjustable.

According to the configurations in FIGS. 10 and 11, the variable matching portion adjusts a matching state by assuming the matching state to be the reference state when the adjustment starts, after it terminates, and when a predetermined timing is reached during the adjustment. The variable matching portion accordingly determines whether to continue adjusting the matching state of the variable matching portion based on the reception signal intensity of the tuning reference signal measured by the reception signal intensity measurement portion.

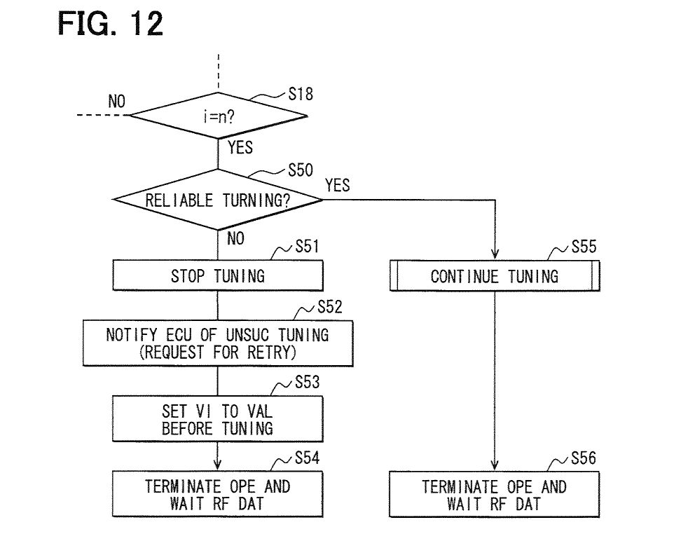

With reference to FIG. 12, the following describes still another example of the process on the onboard unit. The process is a modification of FIG. 4 or 7 and only differences will be described.

The control circuit 131 increments i by 1 from 1 to vary the applied voltage Vi. The control circuit 131 applies the voltage to the variable matching circuit 132 and stores the corresponding RSSI in association with the applied voltage Vi in the memory 131b. If i=n is satisfied (Yes at S18), the control circuit 131 determines whether the tuning is reliable. The determination method will be described later.

Suppose a case where the tuning is determined to be unreliable (No at S50). In such a case, the control circuit 131 stops the tuning (S51). The tuner 103 outputs a signal to the ECU 101 to indicate that the tuning fails (S52). At this time, the tuner 103 may output a request to retry the tuning.

The control circuit 131 sets voltage Vi to be applied to the variable matching circuit 132 to the value that is stored in the memory 131b and takes effect before the tuning, namely, the optimum matching voltage for the previous tuning (S53). The onboard unit 100 terminates the operation in the tuning mode and awaits RF data from the portable unit 200 (S54). The onboard unit 100 may transition to the data communication mode.

Suppose a case where the tuning is determined to be reliable (Yes at S50). In such a case, the control circuit 131 continues the tuning (S55). Namely, the control circuit 131 performs the process at S19 and S20 in FIG. 4 or 7. The onboard unit 100 terminates the operation in the tuning mode, transitions to the data communication mode, and awaits RF data from the portable unit 200 (S56).

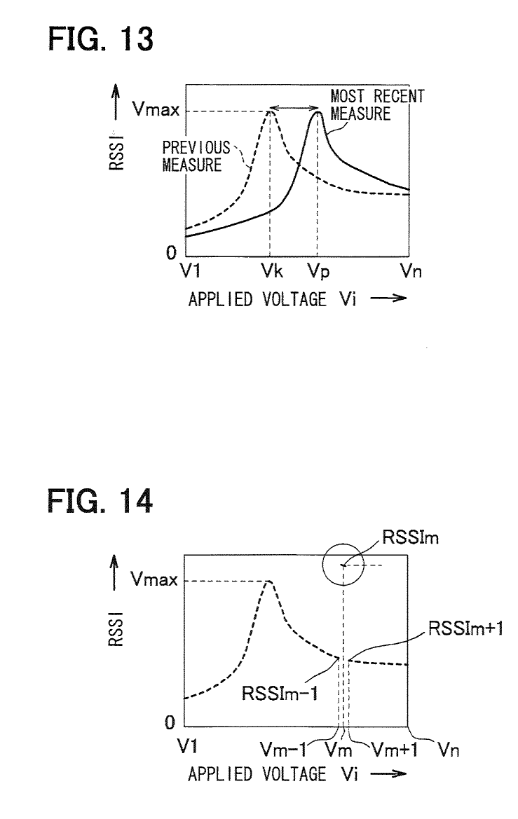

With reference to FIGS. 13 and 14, the following describes the method of determining the tuning reliability. FIGS. 13 and 14 illustrate the relationship between voltage Vi applied to the variable matching circuit 132 and the RSSI in the onboard unit processes (FIGS. 4, 7, and 12) for the above-mentioned antenna matching.

In FIG. 13, a broken line depicts the result of measuring the RSSI during a previous tuning. Applied voltage Vk (the optimum matching voltage stored in the memory 131b) is found when the maximum value Vmax is measured. A solid line depicts the result of measuring the RSSI during the most recent tuning. Applied voltage Vp is found when the maximum value Vmax is measured. The method assumes the most recent tuning to be reliable if a difference between the applied voltages Vk and Vp belongs to a predetermined range. The method assumes the most recent tuning to be unreliable if a difference between the applied voltages Vk and Vp exceeds the predetermined range.

The method is applicable to a case where there is a large difference between the applied voltage found by measuring the maximum RSSI value (equivalent to the resonant frequency for the RF reception antenna 136) during the previous tuning and the applied voltage found by measuring the maximum RSSI value during the most recent tuning. Normally, more than one RF frequency is available. Available RF frequencies are selected from frequency widths depending on car models or destinations. For example, RF frequencies are selected from widths of 5 MHz in the 300 MHz band. The usage environment may cause a frequency difference sufficiently smaller than 5 MHz. The inventors found that initially performing the tuning decreases a frequency width that varies with the usage environment. The tuning can be assumed unreliable if the tuning remarkably changes the frequency.

As illustrated in FIG. 14, the applied voltage Vi is successively changed to Vm−1, Vm, and Vm+1 to measure RSSIm−1, RSSIm, and RSSIm+1 during the tuning. The most recent tuning is assumed reliable if a difference between RSSIm−1 and RSSIm or a difference between RSSIm and RSSIm+1 belongs to a predetermined range. The difference is equivalent to a change ratio between RSSI values at two unspecified or adjacent points. The most recent tuning is assumed unreliable if a difference between RSSI values exceeds the predetermined range. The method is applicable to a case where an RSSI value locally changes due to a pulse noise, for example.

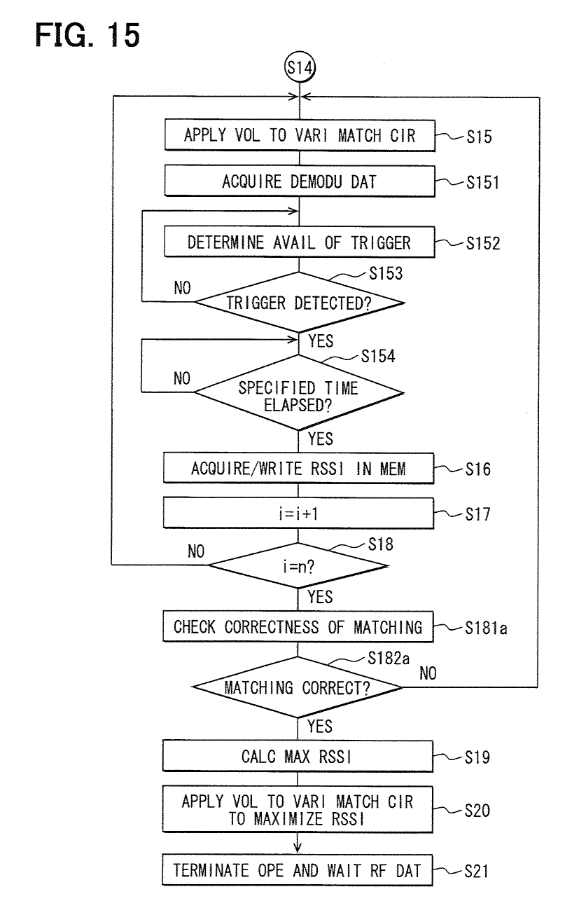

With reference to FIG. 15, the following describes still another example of the onboard unit process and the portable unit process for the antenna matching according to the present disclosure. The processes use an FSK modulation wave as the burst signal (i.e., the tuning reference signal) from the portable unit 200. The processes are a modification of FIG. 4. Only differences from FIG. 4 will be described. The mutually corresponding configurations in FIGS. 15 and 4 are designated by the same reference numerals or are omitted and a detailed description is omitted for simplicity.

According to an example in FIG. 15, the first communication apparatus in the wireless communication system according to the present disclosure includes a demodulation portion to demodulate a wireless signal that is received by the first reception portion and is transmitted from the second communication apparatus. The reception signal intensity measurement portion measures the reception signal intensity of a tuning reference signal received by the first reception portion based on a demodulated signal output from the demodulation portion. The variable matching portion is equivalent to a configuration that adjusts the matching state based on the reception signal intensity of the measured tuning reference signal. The configuration is expected to provide a considerable effect if a modulation wave is used as the tuning reference signal. The configuration using the modulation wave as RF data in the data communication mode allows the portable unit 200 to eliminate a circuit to output a continuous wave. This enables to simplify and miniaturize the circuitry of the portable unit 200.

The portable unit process is similar to that illustrated in FIG. 5. At S36, the burst signal output portion 213 generates and outputs a burst signal as a predetermined data string. The RF modulation circuit 221 performs FSK modulation, for example, and outputs RF data via the RF transmission antenna 222.

The onboard unit 100 performs the process (S22 through S27) similar to FIG. 4 if the data communication mode is selected as the operation mode at S11. A description is omitted for simplicity.

Similar to S11 through S14 in FIG. 4, the onboard unit 100 transmits LF data and awaits RF data from the portable unit 200 if the tuning mode is selected as the operation mode. If RF data is received, the control circuit 131 of the tuner 103 allows the tuning control portion 131a to set i=1. The control circuit 131 sets a voltage (Vi or V1) to be applied to the variable matching circuit 132 (i.e., variable matching element D1). The control circuit 131 converts the digital value into an analog voltage and applies it to the variable matching circuit 132 (S15).

The control circuit 131 acquires demodulation data from the RF modulation circuit 134 (S151). The demodulation data is generated by demodulating the received RF data. Based on the state of the demodulation data, the control circuit 131 detects availability of a trigger using at least one of the following as a trigger.
A rise of the demodulation data (to be described in detail)
A fall of the demodulation data (to be described in detail)

When detecting a trigger (Yes at S153), the control circuit 131 measures the lapse of time from the detection of the trigger and determines whether the predetermined time has elapsed. The predetermined time may be shorter than the modulation cycle for RF data or more preferably shorter than half the modulation cycle, for example.

If the predetermined time has elapsed (Yes at S154), the RSSI detection circuit 135 detects the RSSI and stores it in the memory in association with the applied voltage V1 (S16).

The control circuit 131 then increments i by 1 (S17). The control circuit 131 returns to S15 to change the applied voltage Vi and applies it to the variable matching circuit 132. The RSSI is detected after a lapse of the predetermined time from the time to detect the trigger for the acquired modulation data. The control circuit 131 stores this RSSI in the memory 131b in association with the applied voltage Vi (S151 through S154 and S16).

If i=n (e.g., n=20) is satisfied (Yes at S18), the control circuit 131 checks for correctness of the above-mentioned matching (S181a) using at least one of the following.
The matching is assumed correct if an RSSI increasing gradient and an RSSI decreasing gradient each belong to a predetermined range. The RSSI increasing gradient is found until the RSSI reaches the maximum value. The RSSI decreasing gradient is found after the RSSI reaches the maximum value.
The matching is assumed correct if a difference between the absolute value of an RSSI increasing gradient and the absolute value of an RSSI decreasing gradient belongs to a predetermined range. That is, RSSI waveforms are symmetric to each other with respect to a symmetry axis containing the maximum RSSI value.

If the matching is assumed correct (Yes at S182a), the control circuit 131 calculates a maximum value from the RSSI values stored in the memory 131b as described in FIG. 4. The control circuit 131 applies the applied voltage Vi associated with the maximum RSSI value to the variable matching circuit 132 (S20). The control circuit 131 stores the value of the applied voltage Vi as an optimum matching voltage in the memory 131b. The onboard unit 100 terminates the operation in the tuning mode, transitions to the data communication mode, and awaits RF data from the portable unit 200 (S21).

If the matching is assumed incorrect (No at S182a), the control circuit 131 returns to S15. The control circuit 131 re-applies V1 to the variable matching circuit 132 and retries the matching. The control circuit 131 may stop the matching or may perform a process equivalent to S184 through S186 in FIG. 7.

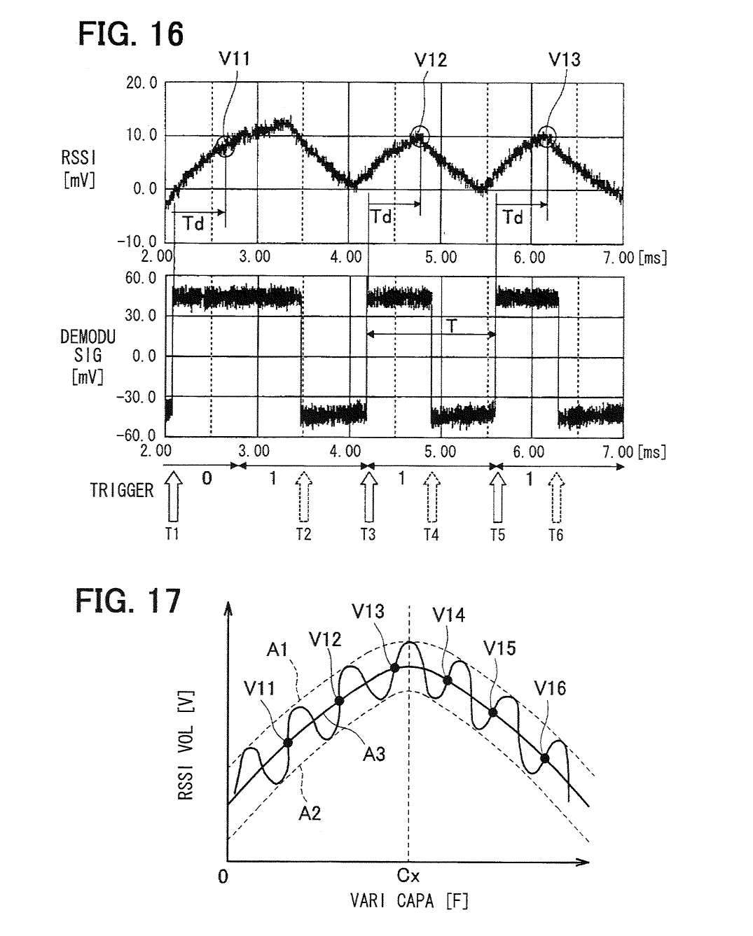

FIG. 16 illustrates relationship among an RSSI waveform received by the onboard unit 100, a waveform resulting from measuring the modulation data, and triggers when the portable unit 200 transmits RF data (314 MHz, FSK modulation signal). The applied voltage Vi is set to a constant value. The transmission time per RF data is measured at modulation cycle T. A demodulated signal (i.e., demodulation data) corresponding to RF data 0 changes from L to H. A demodulated signal corresponding to RF data 1 changes from H to L. The signal output time is assumed to be T. The output time for L and H is assumed to be approximately T/2. In FIG. 16, the demodulated signal outputs 0 (only H for the second half), 1, 1, and 1.

The demodulated signal contains at least one rise (change from L to H) or fall (change from H to L) during the modulation cycle T even if RF data contains a series of 0s or 1s or a combination of 0s and 1s. At least one of the rise and the fall (T1 through T6) may be used as a trigger. The example in FIG. 15 uses rises (T1, T3, and T5) of the demodulated signal as triggers.

As seen from FIG. 16, the demodulated signal rises or falls according as the RSSI rises or falls. The RSSI rise or fall depends on time constants for the RF reception circuit 133 and the RF modulation circuit 134 of the tuner 103 and therefore always forms a specific gradient. Focusing on this, an RSSI is sampled upon expiration of given time (Td) after a trigger is detected in the demodulated signal. Stable values (e.g., V11, V12, and V13) can be detected with no effect of RSSI variations to enable high-precision impedance matching. As described above, the condition is Td<T or more preferably Td<T/2.

The above-mentioned content is equivalent to the configuration according to the present disclosure. That is, the reception signal intensity measurement portion detects a state change in the demodulated signal as a trigger. The reception signal intensity measurement portion measures the reception signal intensity of a tuning reference signal received by the first reception portion upon expiration of the specified time after the trigger is detected. The specified time is set to be shorter than the modulation cycle for the tuning reference signal.

FIG. 17 illustrates relationship between the capacitance (variable capacitance value) of the variable matching element D1 and the RSSI (equivalent to the voltage) in FIG. 15. Increasing the applied voltage Vi decreases the variable capacitance value. The RSSI increases as the variable capacitance value increases. The RSSI is maximized at variable capacitance value Cx and decreases after that.

The RSSI value varies at modulation cycle T (see FIG. 16). Envelope curve A1 corresponds to local maximum values of the variation. Envelope curve A2 corresponds to local minimum values of the variation. Local maximum values and local minimum values vary with the contents of RF data or propagation states. The use of intermediate values can prevent Cx (i.e., applied voltage Vi) from varying (see curve A3).

An increasing gradient of RSSI values corresponds to a gradient of the line connecting between V11 and V13, for example. A decreasing gradient thereof corresponds to a gradient of the line connecting between V14 and V16, for example. The range of the gradients is known according to the circuit configuration of the tuner 103. The correctness of the matching can be estimated by determining whether the increasing gradient and the decreasing gradient belong to a specified range.

Suppose a case where the RSSI values (V11 through V16) are symmetric to each other with respect to the symmetry axis, namely, a line that passes through Cx and is parallel to the RSSI axis. In such a case, the correctness of the matching can be estimated by inspecting the RSSI symmetry. The RSSI symmetry can be inspected by determining whether a difference between the absolute value of the increasing gradient and the absolute value of the decreasing gradient belongs to a specified range.

The two determination methods are equivalent to the following. While the matching state is adjusted, the reception signal intensity measurement portion measures the reception signal intensity of the tuning reference signal. An increasing gradient is found until the reception signal intensity reaches the maximum value. A decreasing gradient is found after the reception signal intensity reaches the maximum value. The matching result determination portion assumes the matching state adjustment to be incorrect if the increasing gradient and the decreasing gradient each exceed a predetermined range.

The two determination methods above may be used to determine the reliability of the tuning at S50 in FIG. 12. The method of determining the tuning reliability at S50 in FIG. 12 may be used to determine the correctness of the matching in FIG. 15.

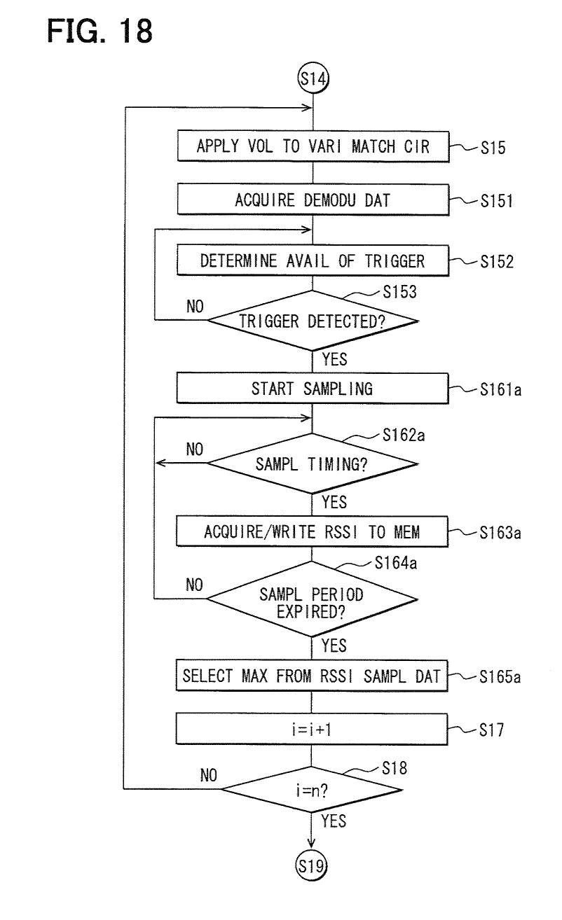

With reference to FIG. 18, the following describes another example of the onboard unit process in FIG. 15. The process is a modification of FIG. 15. Only differences from FIG. 15 will be described. The mutually corresponding configurations in FIGS. 18 and 15 are designated by the same reference numerals or are omitted and a detailed description is omitted for simplicity.

When detecting a trigger (Yes at S153), the control circuit 131 starts sampling the RSSI (S161a). A sampling cycle is assumed to be one tenth of the modulation cycle T, for example. A sampling period is assumed valid during the modulation cycle T or until the next trigger is detected.

When the sampling timing is reached (Yes at S162a), the control circuit 131 stores the RSSI detected by the RSSI detection circuit 135 in the memory 131b (S163a). While the sampling period does not expire (No at S164a), the control circuit 131 returns to S162a and repeats the RSSI sampling.

When the sampling period has expired (Yes at S164a), the control circuit 131 selects the maximum value from the RSSI values sampled during the sampling period. The control circuit 131 stores the maximum value in the memory 131b as the RSSI corresponding to the applied voltage Vi (i.e., V1) during the sampling period in association with the applied voltage Vi (S165a).

The control circuit 131 then increments i by 1 (S17). The control circuit 131 returns to S15 to change the applied voltage Vi and applies it to the variable matching circuit 132. The control circuit 131 samples the RSSI when detecting the trigger for the acquired demodulation data. The control circuit 131 stores the maximum RSSI value in the memory 131b in association with the applied voltage Vi.

The above-mentioned process is equivalent to the configuration according to the present disclosure as follows. The reception signal intensity measurement portion detects a state change in the demodulated signal as a trigger. The reception signal intensity measurement portion samples the reception signal intensity of a tuning reference signal (received by the first reception portion) for a predetermined period. The reception signal intensity measurement portion assumes the maximum value out of the sampled reception signal intensities to be the reception signal intensity for that period.

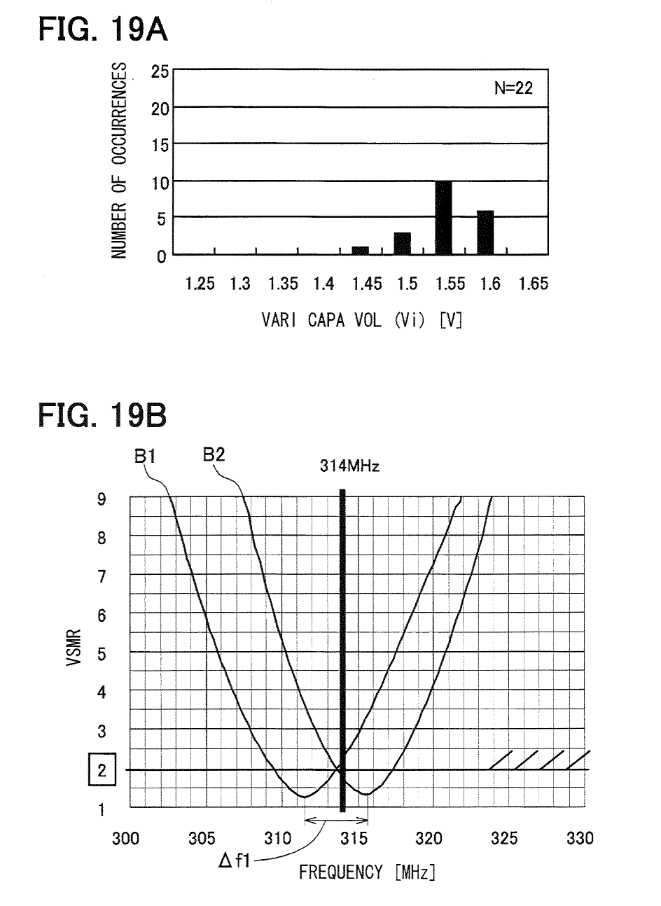

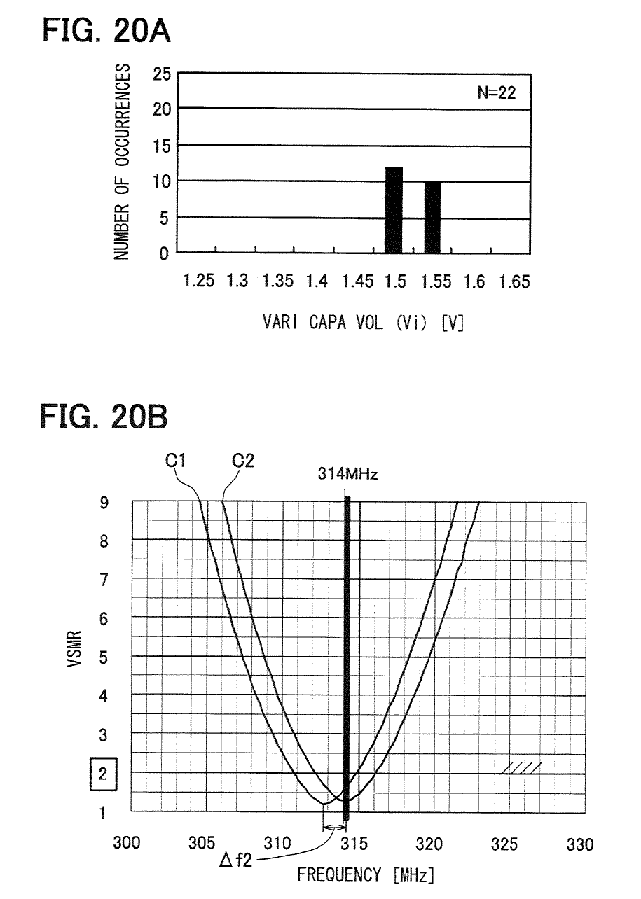

FIGS. 19A, 19B, 20A and 20B illustrate variations of variable capacitance voltages (optimum matching voltages equivalent to the applied voltage Vi corresponding to the maximum RSSI) applied to the variable matching circuit 132 and results of measuring VSWR (Voltage Standing Wave Ratio) indicating impedance matching states of the antenna. The number of measurements N is 22. FIGS. 19A and 19B provide measurement results according to a configuration of a comparison. FIGS. 20A and 20B provide measurement results according to the configurations as described in FIGS. 15 through 18. Generally, the matching is assumed sufficient if the VSWR goes below 2.

According to FIGS. 19A and 19B, a variation of the variable capacitance voltages is equivalent to 0.15 V (1.60-1.45). The resonant frequency of 311.5 MHz is acquired from VSWR (B1) at the variable capacitance voltage of 1.45 V. The resonant frequency of 315.5 MHz is acquired from VSWR (B2) at the variable capacitance voltage of 1.60 V. As a result, a VSWR variation width is estimated to be Δf1=4 MHz.

According to FIGS. 20A and 20B, a variation of the variable capacitance voltages is equivalent to 0.05 V (1.55-1.50). The resonant frequency of 312.8 MHz is acquired from VSWR (C1) at the variable capacitance voltage of 1.50 V. The resonant frequency of 314.0 MHz is acquired from VSWR (C2) at the variable capacitance voltage of 1.55 V. As a result, a VSWR variation width is estimated to be Δf2=approximately 1 MHz. FIG. 20 shows that variations in the variable capacitance voltage and the VSWR decrease to greatly improve the accuracy of impedance matching.

The present disclosure is applicable to a vehicular smart keyless entry system and a non-vehicular wireless communication system including an apparatus provided with an LF transmitter and an RF receiver and an apparatus that is configured independently of that apparatus and is provided with an LF transmitter and an RF receiver.

The above disclosure has the following aspects.

According to an example aspect of the present disclosure, a wireless communication system includes: a first communication apparatus; and a second communication apparatus for wirelessly communicating with the first communication apparatus. The first communication apparatus includes: a first transmission portion that transmits a wireless signal to the second communication apparatus using a radio wave in a first frequency band; a first reception portion that receives a wireless signal from the second communication apparatus; a reception antenna connected to the first reception portion; a variable matching portion that variably adjusts a matching state between the first reception portion and the reception antenna within a predetermined matching range; a reception signal intensity measurement portion that measures a reception signal intensity of a wireless signal that is received by the first reception portion and is transmitted from the second communication apparatus; and an operation mode changeover control portion that switches an operation mode of the first communication apparatus between a normal mode and a tuning-mode. The tuning mode is different from the normal mode, in which the first communication apparatus normally functions. The variable matching portion adjusts the matching state in the tuning mode. The first transmission portion transmits an operation mode transition request signal to the second communication apparatus when the operation mode changeover control portion changes the operation mode to the tuning mode. The first reception portion receives a tuning reference signal transmitted from the second communication apparatus in response to the operation mode transition request signal. The reception signal intensity measurement portion measures the reception signal intensity of the tuning reference signal received by the first reception portion. The variable matching portion adjusts the matching state based on the reception signal intensity of the tuning reference signal measured by the reception signal intensity measurement portion. The second communication apparatus includes: a second reception portion that receives a wireless signal from the first communication apparatus; a second transmission portion that transmits a wireless signal to the first communication apparatus; and a signal determination portion that determines whether a wireless signal received by the second reception portion and transmitted from the first communication apparatus is equivalent to the operation mode transition request signal. The second transmission portion transmits the tuning reference signal using a radio wave in a second frequency band when the wireless signal received from the first communication apparatus is equivalent to the operation mode transition request signal.

The above-mentioned configuration can accurately adjust the matching state using the tuning reference signal different from wireless signals normally received for broadcasting or data communication. The matching state is adjusted in a state different from the normal operation mode. The normal wireless communication is not affected. Antenna matching is equivalent to adjustment of an antenna resonant frequency. Generally, the capacitor capacitance is varied for this purpose. The variable matching portion includes a variable-capacitance diode. The matching state can be adjusted according to a simpler configuration. A continuous wave (CW) ensures constant signal amplitude and power and can be used as the tuning reference signal. In this case, even a normal communication system can more accurately adjust the matching state.

Alternatively, the variable matching portion may include a variable-capacitance diode for varying a capacitance value. The reception signal intensity measurement portion measures the reception signal intensity of the wireless signal received by the first reception portion and transmitted from the second communication apparatus with respect to each capacitance value of the variable-capacitance diode. The variable matching portion adjusts the matching state by setting the variable-capacitance diode to a capacitance value corresponding to a maximum value of the reception signal intensity.

Alternatively, the variable matching portion may set the matching state to be the reference matching state at least twice while adjusting the matching state. The continuation adjustment determination portion determines whether the variable matching portion continues adjusting the matching state, based on the reception signal intensity of the tuning reference signal measured by the reception signal intensity measurement portion at each time the matching state is set to be the reference state. The above-mentioned configuration enables to detect a change in the reception signal intensity due to a cause other than a modulation wave during the tuning. The matching state can be adjusted only when a radio wave is stable. The matching accuracy improves. The first communication apparatus can more reliably receive a wireless signal from the second communication apparatus.

Alternatively, the wireless communication system further includes: a storage portion that stores the reception signal intensity of the tuning reference signal when the variable matching portion changes the matching state within the predetermined matching range; and a matching result determination portion that determines whether adjusting of the matching state with the variable matching portion is proper, based on the reception signal intensity stored in the storage portion. The variable matching portion resets the matching state to a state before adjusting the matching state when the matching result determination portion determines that the adjusting of the matching state is not proper. Further, when a difference between a previous matching state and a recent matching state adjusted by the variable matching portion exceeds a predetermined threshold value, the matching result determination portion may determine that the recent matching state is not proper. According to the above-mentioned configuration, the matching state is changed only when the tuning is performed reliably. The matching accuracy more improves.

Alternatively, the radio wave in the first frequency band may be a low-frequency band having a frequency lower than a predetermined frequency. Further, the radio wave in the second frequency band may be a high-frequency band having a frequency higher than a predetermined frequency. For example, the LF-band communication uses a low-frequency band of 100 kHz. The LF-band communication ensures a communication range of relatively short distance, provides relatively large transmission power (strong magnetic field), and is hardly interfered by other radio waves. For example, the RF-band communication uses a high-frequency band of 300 MHz. The RF-band communication can ensure a communication range of relatively long distance for its transmission power. The wireless communication system according to the above-mentioned configuration is appropriate to a case of limiting communication to that between the first communication apparatus and the second communication apparatus both located at a relatively short distance.

Alternatively, the wireless communication system may provide a smart keyless entry system for wirelessly communicating between an in-vehicle unit mounted on a vehicle and a portable unit carried by a user. The first communication apparatus is the in-vehicle unit, and the second communication apparatus is the portable unit. The first transmission portion provides a polling signal transmission portion for transmitting a polling signal that polls the portable unit. The first reception portion provides an ID code reception portion for receiving an ID code transmitted from the portable unit in response to the polling signal. The second reception portion provides a polling signal reception portion for receiving the polling signal. The second transmission portion provides an ID code transmission portion for transmitting the ID code in response to the polling signal. The in-vehicle unit further includes: a data verification portion for verifying the ID code received by the ID code reception portion with reference to a master code stored in the data verification portion; and an operation permission portion for permitting an operation of a predetermined function in the vehicle based on a verification result of the data verification portion. In the smart keyless entry system, for example, the onboard unit performs polling using an LF-band radio wave. The portable unit transmits an ID code using an RF-band radio wave. The communication between the onboard unit and the portable unit is limited to a relatively short distance in consideration of security (e.g., protection against theft). A matching state can be accurately adjusted if the above-mentioned wireless communication system is applied to the smart keyless entry system. User-friendliness can be improved to avoid a possibility where a vehicle may not operate in response to an operation on the portable unit.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A wireless communication system comprising:
a first communication apparatus; and
a second communication apparatus for wirelessly communicating with the first communication apparatus,
wherein the first communication apparatus includes:
a first transmission portion that transmits a wireless signal to the second communication apparatus using a radio wave in a first frequency band;
a first reception portion that receives a wireless signal from the second communication apparatus;
a reception antenna connected to the first reception portion;
a variable matching portion that variably adjusts a matching state between the first reception portion and the reception antenna within a predetermined matching range;
a reception signal intensity measurement portion that measures a reception signal intensity of a wireless signal that is received by the first reception portion and is transmitted from the second communication apparatus;
an operation mode changeover control portion that switches an operation mode of the first communication apparatus between a normal mode and a tuning mode,
wherein the tuning mode is different from the normal mode, in which the first communication apparatus normally functions,
wherein the variable matching portion adjusts the matching state in the tuning mode,
wherein the first transmission portion transmits an operation mode transition request signal to the second communication apparatus when the operation mode changeover control portion changes the operation mode to the tuning mode;
wherein the first reception portion receives a tuning reference signal transmitted from the second communication apparatus in response to the operation mode transition request signal;
wherein the reception signal intensity measurement portion measures the reception signal intensity of the tuning reference signal received by the first reception portion;
wherein the variable matching portion adjusts the matching state based on the reception signal intensity of the tuning reference signal measured by the reception signal intensity measurement portion,
wherein the second communication apparatus includes:
a second reception portion that receives a wireless signal from the first communication apparatus;
a second transmission portion that transmits a wireless signal to the first communication apparatus; and
a signal determination portion that determines whether a wireless signal received by the second reception portion and transmitted from the first communication apparatus is equivalent to the operation mode transition request signal, and
wherein the second transmission portion transmits the tuning reference signal using a radio wave in a second frequency band when the wireless signal received from the first communication apparatus is equivalent to the operation mode transition request signal.

2. The wireless communication system according to claim 1,
wherein the variable matching portion includes a variable-capacitance diode for varying a capacitance value,
wherein the reception signal intensity measurement portion measures the reception signal intensity of the wireless signal received by the first reception portion and transmitted from the second communication apparatus with respect to each capacitance value of the variable-capacitance diode, and
wherein the variable matching portion adjusts the matching state by setting the variable-capacitance diode to a capacitance value corresponding to a maximum value of the reception signal intensity.

3. The wireless communication system according to claim 1,
wherein the tuning reference signal is a continuous radio wave.

4. The wireless communication system according to claim 1,
wherein the first communication apparatus further includes a demodulation portion that demodulates the wireless signal received by the first reception portion and transmitted from the second communication apparatus;
wherein the reception signal intensity measurement portion measures the reception signal intensity of the tuning reference signal received by the first reception portion based on a state of a demodulated wireless signal output from the demodulation portion, and
wherein the variable matching portion adjusts the matching state based on the reception signal intensity of the tuning reference signal.

5. The wireless communication system according to claim 4,
wherein the tuning reference signal is a modulation radio wave.

6. The wireless communication system according to claim 4,
wherein the reception signal intensity measurement portion detects a state change in the demodulated signal as a trigger and measures the reception signal intensity of the tuning reference signal received by the first reception portion upon expiration of a predetermined time interval after the trigger is detected.

7. The wireless communication system according to claim 6,
wherein the predetermined time interval is shorter than a modulation cycle of the tuning reference signal.

8. The wireless communication system according to claim 4,
wherein the reception signal intensity measurement portion detects a state change in the demodulated signal as a trigger, samples a plurality of reception signal intensities of the tuning reference signal received by the first reception portion for a predetermined period, and sets a maximum value in sampled reception signal intensities to be a current reception signal intensity.

9. The wireless communication system according to claim 1,
wherein the variable matching portion further includes a continuation adjustment determination portion that determines whether the variable matching portion continues adjusting the matching state, based on the reception signal intensity of the tuning reference signal measured by the reception signal intensity measurement portion when the matching state is a predetermined matching state as a reference matching state.

10. The wireless communication system according to claim 9,
wherein the variable matching portion sets the matching state to be the reference matching state at least twice while adjusting the matching state, and
wherein the continuation adjustment determination portion determines whether the variable matching portion continues adjusting the matching state, based on the reception signal intensity of the tuning reference signal measured by the reception signal intensity measurement portion at each time the matching state is set to be the reference state.

11. The wireless communication system according to of claim 1, further comprising:
a storage portion that stores the reception signal intensity of the tuning reference signal when the variable matching portion changes the matching state within the predetermined matching range; and
a matching result determination portion that determines whether adjusting of the matching state with the variable matching portion is proper, based on the reception signal intensity stored in the storage portion,
wherein the variable matching portion resets the matching state to a state before adjusting the matching state when the matching result determination portion determines that the adjusting of the matching state is not proper.

12. The wireless communication system according to claim 11,
wherein, when a difference between a previous matching state and a recent matching state adjusted by the variable matching portion exceeds a predetermined threshold value, the matching result determination portion determines that the recent matching state is not proper.

13. The wireless communication system according to claim 11,
wherein the matching result determination portion determines that the matching state is not proper when there are a plurality of local maximum values of the reception signal intensity of the tuning reference signal measured by the reception signal intensity measurement portion while adjusting the matching state.

14. The wireless communication system according to claim 11,
wherein the matching result determination portion determines that the matching state is not proper when each of an increasing gradient and a decreasing gradient of the reception signal intensity exceeds a predetermined range,
wherein the reception signal intensity increases with the increasing gradient before the reception signal intensity reaches a maximum value when the reception signal intensity measurement portion measures the reception signal intensity of the tuning reference signal while adjusting the matching state, and
wherein the reception signal intensity decreases with the decreasing gradient after the reception signal intensity reaches the maximum value when the reception signal intensity measurement portion measures the reception signal intensity of the tuning reference signal while adjusting the matching state.

15. The wireless communication system according to claim 1,
wherein the radio wave in the first frequency band is a low-frequency band having a frequency lower than a predetermined frequency.

16. The wireless communication system according to claim 1,
wherein the radio wave in the second frequency band is a high-frequency band having a frequency higher than a predetermined frequency.

17. The wireless communication system according to claim 1,
wherein the wireless communication system provides a smart keyless entry system for wirelessly communicating between an in-vehicle unit mounted on a vehicle and a portable unit carried by a user,
wherein the first communication apparatus is the in-vehicle unit, and the second communication apparatus is the portable unit,
wherein the first transmission portion provides a polling signal transmission portion for transmitting a polling signal that polls the portable unit,
wherein the first reception portion provides an ID code reception portion for receiving an ID code transmitted from the portable unit in response to the polling signal,
wherein the second reception portion provides a polling signal reception portion for receiving the polling signal,
wherein the second transmission portion provides an ID code transmission portion for transmitting the ID code in response to the polling signal,
wherein the in-vehicle unit further includes:
a data verification portion for verifying the ID code received by the ID code reception portion with reference to a master code stored in the data verification portion; and
an operation permission portion for permitting an operation of a predetermined function in the vehicle based on a verification result of the data verification portion.
